(19) United States
(12) Patent Application Publication
(10) Pub. No.: US 2014/0164796 A1
(43) Pub. Date: Jun. 12, 2014

(54) SYSTEMS AND METHODS FOR PROVIDING IMPROVED POWER BACKUP FOR DESKTOP COMPUTERS

(71) Applicants: RAMESH NADHADUR RANGARAJAN, BANGALORE (IN); BALA ADARSH ANTHAPPA, BANGALORE (IN); SRINIVASA MURTHY RAGHAVENDRA PRAKASH, BANGALORE (IN)

(72) Inventors: RAMESH NADHADUR RANGARAJAN, BANGALORE (IN); BALA ADARSH ANTHAPPA, BANGALORE (IN); SRINIVASA MURTHY RAGHAVENDRA PRAKASH, BANGALORE (IN)

(73) Assignee: WIPRO LIMITED, Bangalore (IN)

(21) Appl. No.: 13/773,614

(22) Filed: Feb. 21, 2013

(30) Foreign Application Priority Data
Dec. 12, 2012 (IN) 5182/CHE/2012

(51) Int. Cl. G06F 1/26

(52) U.S. Cl. CPC G06F 1/26
USPC 713/300

(57) ABSTRACT

The present disclosure relates to systems and methods for providing power from a secondary power source upon an interruption of a primary power source. In certain embodiments, the secondary power source may supply power without use of a power inverter that converts direct current into alternating current or a current rectifier that provides a second conversion of alternating current into a direct current. Embodiments in accordance with the present disclosure may also employ a time delay to improve operation of the secondary power source.

### RELATED APPLICATIONS

This disclosure claims priority under 35 U.S.C. §119 to Indian Provisional Patent Application 5182/CHE/2012, filed Dec. 12, 2012. The aforementioned application is incorporated herein by reference in its entirety.

### TECHNICAL FIELD

Embodiments of the present disclosure generally relate to power backup systems and methods and, more specifically, to systems and methods to provide power backup for computing devices.

### BACKGROUND

Computing devices have evolved rapidly over the last several decades, and notebooks, tablets, and smartphones have to a large extent replaced traditional desktop systems. Desktop computing systems, however, retain certain advantages over notebooks and handheld devices. For example, desktop systems provide better physical security because they are not easily moved. Also, desktop systems typically cost less notebooks and handheld devices. Thus, desktop computing systems remain preferred over other computing devices in some application areas, such as computing in rural and/or remote areas.

In a number of areas where desktop computers would normally be preferred, power can be unreliable or only sporadically available. Thus, desktop computing systems may often be externally supported with Uninterruptible Power Supplies (UPS), which provide backup power in the absence of the main power supply. Such backup systems require separate wiring and power tapping to adapt the UPS to a desktop system's motherboard and display. This arrangement in turn requires additional infrastructure, cost, and inconvenience for the user. The additional circuit complexity may also increase the likelihood of faults, as well as complications, such as data loss after a fault. Additionally, conventional systems typically require three separate power conversions, each of which contributes to power loss and overall inefficiency. The first conversion rectifies Alternating Current (AC) to Direct Current (DC) to charge the UPS battery. Desktop systems, however, are generally wired to receive AC input, which in turn mandates that the DC output from the UPS be converted back to AC when used in place of the main power supply. Thus, the second conversion employs inverters to convert DC to AC, which is then supplied to a Switched-Mode Power Supply (SMPS) inside the desktop computing system. There, the converted AC is again converted back to DC for use by the motherboard. Thus, for the third conversion, the SMPS converts AC to DC to feed the motherboard and other components. This constitutes three stages of conversion each of which suffers losses of up to 10-15% of input power.

Accordingly, a need exists to provide improved power backup of computing devices.

### SUMMARY

Embodiments in accordance with the present disclosure relate to a system for providing power to a first device and a second device from a secondary power source comprising: a current rectifier; a first switch; a second switch; and a secondary power source management system; wherein the current rectifier converts a primary power source comprising an alternating current into a direct current that supplies power to the first device, the second device, and the secondary power source management system; wherein, upon an interruption in the primary power source, the first switch activates to allow the secondary power source to directly supply power to the first device and, following a time delay, signals the second switch to allow the secondary power source to directly supply power to the second device; and wherein the secondary power source supplies power to the first device and second device using direct current. In certain embodiments, the secondary power source supplies power to the first device and second device without use of a power inverter that converts direct current into alternating current or a current rectifier that provides a second conversion of alternating current into a direct current.

Embodiments in accordance with the present disclosure also relate to a method for providing power to a first device and a second device from a secondary power source comprising: rectifying a primary power source that supplies power to the first device and the second device from an alternating current to a direct current; detecting an interruption in the primary power source; upon detecting an interruption in the primary source, supplying power directly to the first device from the secondary power source and, following a time delay, supplying power directly to the second device from the secondary power source using direct current. In certain embodiments of methods in accordance with the present disclosure, no other rectifying step is performed.

It is to be understood that both the foregoing general description and the following detailed description are exemplary and explanatory only and are not restrictive of disclosed embodiments, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a desktop computing system according to one embodiment of the present disclosure.

FIG. 2 is a block diagram of a power supply management system for a desktop computer according to one embodiment of the present disclosure.

FIG. 3 is a flow diagram of an exemplary power backup method according to one embodiment of the present disclosure.

FIG. 4 is a timing diagram corresponding to the power supply management system in accordance with one embodiment of the present disclosure.

### DETAILED DESCRIPTION

Exemplary embodiments are described with reference to the accompanying drawings. Wherever convenient, the same reference numbers are used throughout the drawings to refer to the same or like parts. In the following description, numerous specific details are set forth to provide a thorough understanding of the present disclosure. It will be clear to one skilled in the art, however, that the present disclosure may be practiced without some or all of these details. In other instances, well known process steps have not been described in detail in order to avoid unnecessarily obscuring the present disclosure. Thus, while examples and features of disclosed principles are described herein, modifications, adaptations, and other implementations are possible without departing from the spirit and scope of the disclosed embodiments. For example, embodiments may be described in connection with desktop computers for ease of discussion. It is to be understood, however, that disclosed embodiments are not limited to desktop computers and may, in fact, be applied to any electronic device capable of employing a backup. It is intended that the following detailed description be considered as exemplary only, with the true scope and spirit being indicated by the following claims.

Systems and methods for providing power from a secondary power source to a first device and a second device are disclosed. Consistent with disclosed embodiments, the system may comprise a current rectifier, first and second devices that consume power, a secondary power source, and a secondary power source management system. The current rectifier may convert a primary power source comprising an Alternating Current (AC) into Direct Current (DC), which in turn may supply power to the first power-consuming device, second power-consuming device, and secondary power source management system. Upon an interruption in the primary power source, a first switch may be activated to allow the secondary power source to supply power directly to the first device and, following a time delay, to the second device. The delay reduces the initial load placed on the battery, resulting in better operation and improved health of the battery. Low-power components may be used in the first device and/or second device to further reduce overall power requirements.

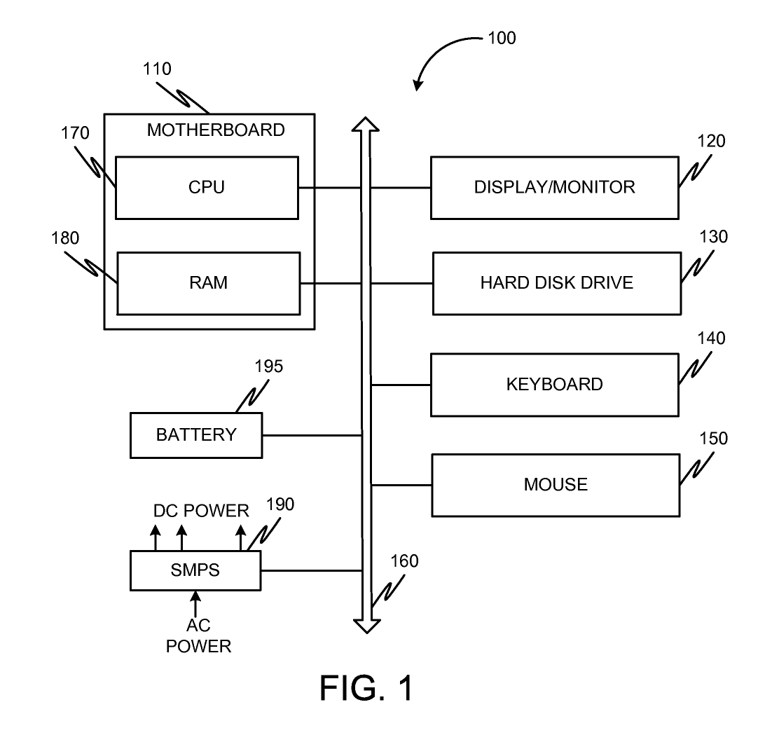

In an exemplary embodiment (shown in FIG. 1), the first device is a computer motherboard 110, and the second device is a display/monitor 120. Both devices may be components in a desktop computing system 100. Although a desktop computing system 100 is one embodiment of the present disclosure, other devices and/or settings may equally profit from the systems and methods herein set forth. The desktop computing system 100 may also include auxiliary storage devices such as a hard disk drive 130, and input devices such as a keyboard 140 and mouse 150. The various components of the desktop computing system 100 may inter-communicate over a bus 160, which may be part of the motherboard 110. The display 120, in some embodiments, is a DC display.

Consistent with disclosed embodiments, the motherboard 110 may further include a Central Processing Unit (CPU) 170 for controlling system operation and a memory, such as RAM 180. Further, the motherboard 110 may use low-power components having a composite power rating less than 45 watts, for example, as compared to the power rating of approximately 150 watts for components used in a typical computer.

The current rectifier may be a Switched-Mode Power Supply (SMPS) 190 configured to convert the AC output of a primary or main power source to Direct Current (DC) capable of supplying power to the computer motherboard 110, display 120, and/or rechargeable battery 195 (the secondary power source). According to some embodiments, the SMPS 190 may be designed to accept input voltage fluctuations in the range 100 volts to 300 volts AC at 50 Hz.

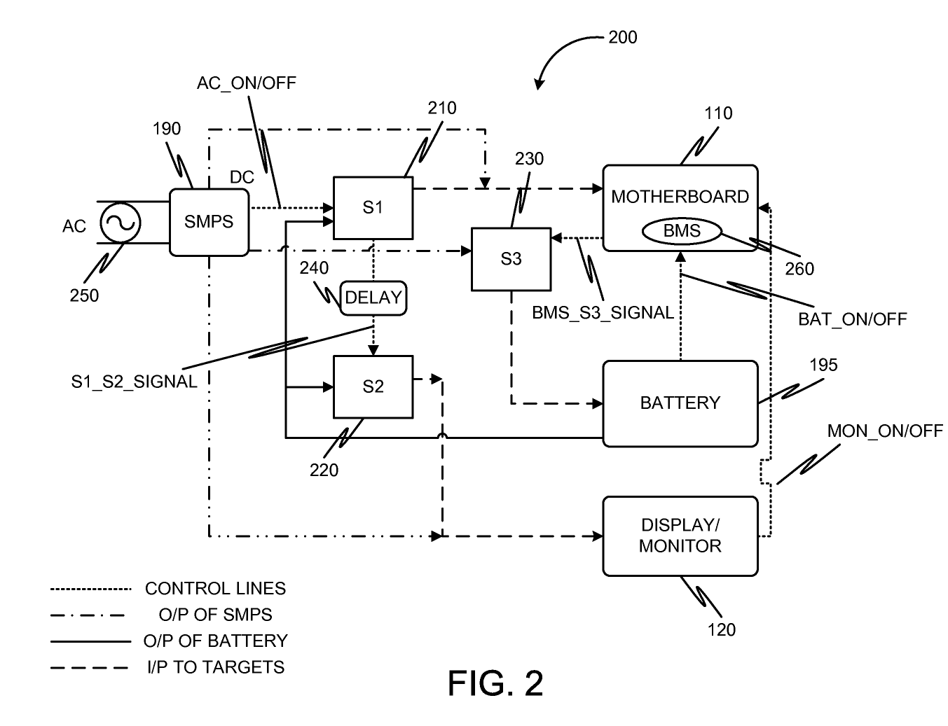

Disclosed embodiments in accordance with the present disclosure are explained in further detail in conjunction with FIGS. 2, 3, and 4 below. FIG. 2 illustrates a power supply management system 200 capable of use with the desktop computing system 100 according to one embodiment of the present disclosure. This system may switch over to battery power when the main power supply fails, employing that battery power to provide DC power to the motherboard 110 and the display 120. In contrast to conventional backup power supplies, the systems in accordance with the present disclosure do not reconvert DC to AC, and do not re-reconvert that AC into DC. Certain embodiments of the systems in accordance with the present disclosure may employ only one AC to DC conversion.

In addition to the SMPS 190 and the battery 195, the power supply management system 200 includes control switches S1 210 (the first switch), S2 220 (the second switch), S3 230 (the third switch), and a delay element 240, interconnected by control lines as shown, as well as elements of bus 160.

The SMPS 190 may receive an AC input from primary power source 250, which it may rectify to obtain a DC output. This output may power the motherboard 110, the display 120, and to the battery 195 through the switches, S1 210, S2 220, and S3 230, employing lines labeled “O/P of SMPS” and “UP to targets,” reflecting the power output of the SMPS 190 and the power input to various other components of the system 200, e.g. the first device comprising a motherboard 110 and a second device comprising a display 120. Further, the SMPS 190 may provide a signal AC_ON/OFF to the switch S1 210. That signal may control the DC supply to the motherboard 110. When the main power supply current is interrupted, the signal AC_ON/OFF goes low, turning switch S1 210 to the ON state, which in turn may enable the battery 195 to provide backup power to the motherboard 110. When main power supply is restored, switch S1 210 turns OFF, which may terminate the power from battery 195 to motherboard 110.

Further, a control signal S1_S2_SIGNAL from switch S1 210 may be generated by the state change of switch S1 210 from OFF to ON. That signal may activate switch S2 220, which may enable the battery 195 to provide backup power to the display 120. According to some embodiments, control signal S1_S2_SIGNAL may be delayed by the delay element 240, introduced to avoid imposing a sudden load on the battery 195. This delay results in, among other things, better operation and improved health of the battery 195. The delay period may be configured by a user and, in certain embodiments, the delay period may be adjusted based on the capacitance of the display 120 to maintain the continued operation of the display 120. In certain embodiments, the delay period may be range from 200 microseconds to 300 microseconds. Switch S2 220 may return to the OFF state when the primary power source is restored.

During normal AC-powered operation, the secondary power source management system may apply a charging current to battery 195, based on its power level, as may be indicated by the voltage across the battery terminals. As in the illustrated embodiment of FIG. 2, the secondary power source management system may include a Battery Monitoring System (BMS) 260, operating in conjunction with switch S3 230 to charge battery 195. The BMS 260 may be a module carried on motherboard 110, and it may control the DC power supplied by the SMPS 190 to the battery 195 via signal BMS_S3_SIGNAL to switch S3 230. For example, when the main power supply 250 is operational and the BMS 260 has determined that the battery is not fully charged, the signal BMS_S3_SIGNAL goes high to enable charging of the battery 195. Alternatively, when the main power supply 250 is not available, the signal BMS_S3_SIGNAL goes low and may terminate charging of the battery 195. The BMS 260 may collect battery level information (such as battery status BAT_ON/OFF) to control the charging of the battery when AC power is available to the SMPS 190. Battery level information may be collected, for example, through voltage sensors known in the art. In some embodiments, the CPU 170 may display the various line voltages and controls the switches S1 210, S2 220, S3 230.

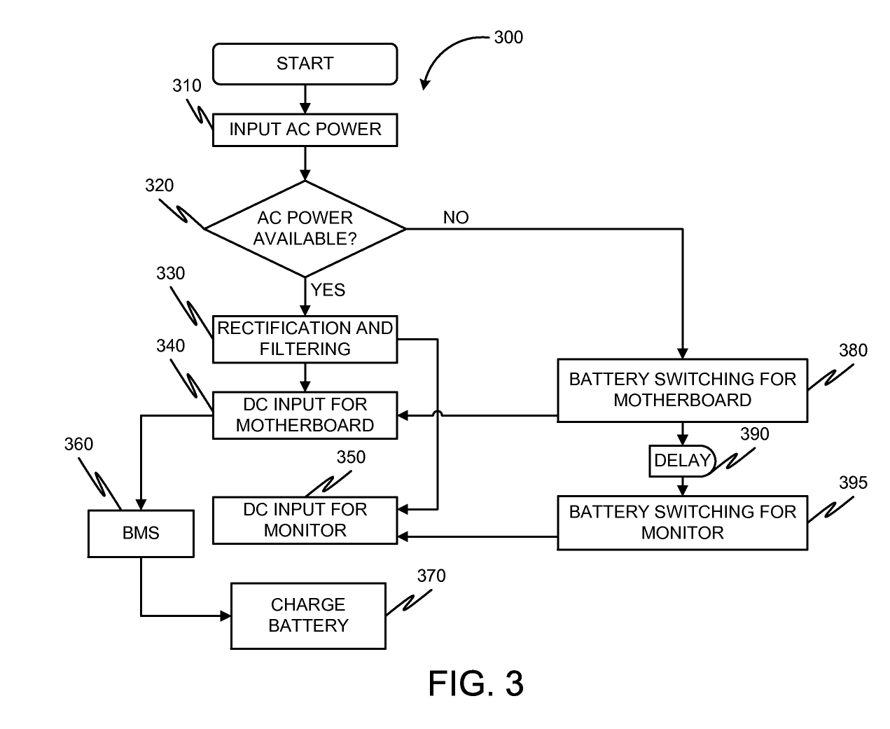

FIG. 3 is a flow diagram of a power backup method 300 in accordance with the present disclosure. At step 310, the SMPS 190 may receive AC power from the primary or main power supply 250, and a signal indicating that voltage is output by SMPS 190. The presence or absence of AC power at SMPS 190 may be indicated by the level of signal AC_ON/OFF output from SMPS 190 to switch S1 210, as noted above.

If AC power is available, that current may be rectified and filtered to provide DC using a single stage AC-DC conversion at step 330. The DC output may be provided to power the motherboard 110 at step 340 and to power the display 120 at step 350. Further, when the main power supply 250 is available the BMS 260 may send the control signal BMS_S3_SIGNAL to turn on switch S3 230 at step 360 to enable battery charging (step 370), e.g. when the battery 195 is not fully charged.

If, however, AC power is not available to the SMPS 190, switch S1 210 may turn on in response to control signal AC_ON/OFF, which may be activated in response to the AC voltage level dropping by a predefined amount based on the output voltage of the SMPS 190 (step 320). Thereafter, power from the battery 195 may be provided to the motherboard 110 at step 380. Activation of switch S1 210 may also send signal S1_S2_SIGNAL to activate switch S2 220. A delay element 240 (step 390) may impose a pre-defined delay before closing switch S2 220 to supply battery power to display 120 (step 395).

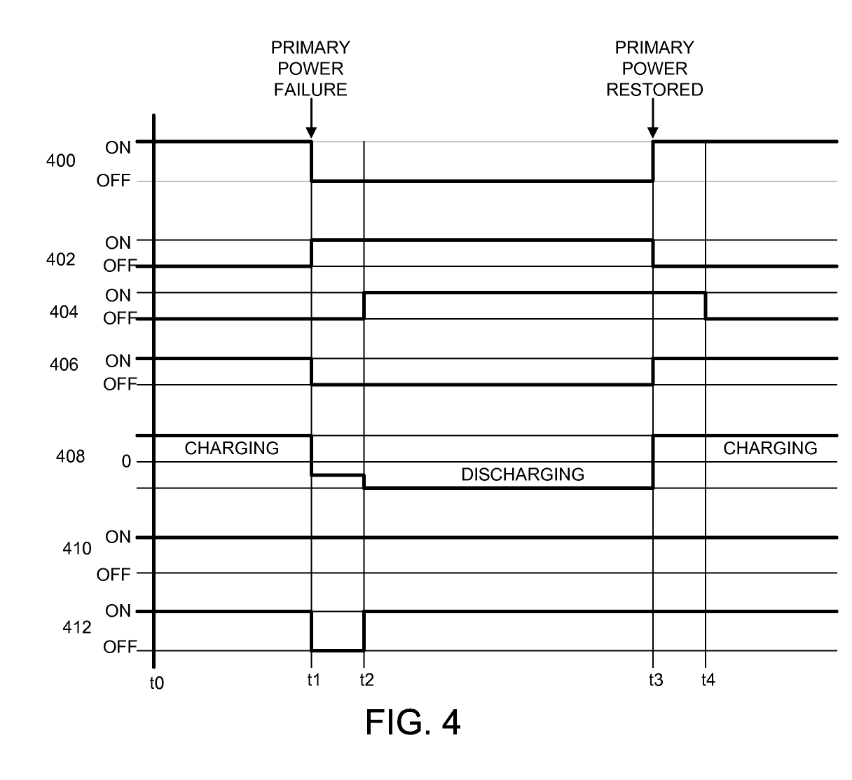

FIG. 4 is a timing diagram for the desktop computing system 100 according to some embodiments of the present disclosure. The timing diagram shows timing lines for the state of the primary power source (for example, as indicated by signal AC_ON/OFF) 400, switch S1 402, switch S2 404, switch S3 406, the battery voltage level (Battery Power Consumption) 408, the voltage input to the motherboard (Motherboard Input Voltage) 410, and the voltage input to the display (Display Input Voltage) 412.

Consistent with disclosed embodiments, the primary power source 250 comprising AC power is available at time t0. The presence of AC power may drive AC_ON/OFF 400 high, which may turn switches S1 210 and S2 220 to OFF. Further, assuming that the battery 195 is not fully charged, the BMS 260 may send the control signal BMS_S3_SIGNAL to activate switch S3 230. Therefore, the battery 195 may receive DC power from the SMPS 190 until it is fully charged. During charging, the display 120 and the motherboard 110 may receive power directly from the SMPS 190, as indicated by timing lines 410 and 412, respectively.

At time t1, the AC power source is interrupted and the signal AC_ON/OFF 400 may go low. This transition may activate the switch S1 210, supplying power from battery 195 to the motherboard 110. The status of the switch control line is shown by switch S1 timing line 402 going high. As a result of a delay element 240, turning on the switch S2 220 may be delayed by the delay circuit, and therefore timing line for switch S2 404 goes high only at time t2, which initiates the battery power supply to the display 120. After t2, the battery 195 increases its discharge level as it begins to provide backup power to both the motherboard 110 and the display 120. This situation is shown by the additional drop in voltage across the battery terminals. Therefore, as shown by timing line 412, the display 120 may remain switched OFF during the delay period. Alternatively, the delay period may be altered by configuring the delay time based on the capacitance of the display 120 so as to maintain the continued operation of the display 120 in spite of a delay in power supply to the display from the battery. Further, the BMS 260 may cause the control signal BMS_S3_SWITCH signal to go low, turning off the switch S3 230, such behavior shown by switch S3 timing line 406.

Thereafter, at time t3, the AC power may be restored. Consequently, the AC_ON/OFF 400 may go high, thus deactivating switch S1 210 and switch S2 220 while activating switch S3 230. The behavior of the switches is shown in lines 402, 404, and 406. The motherboard 110, the display 120, and the battery 195 may start receiving power supply directly from the SMPS 190. Therefore, the battery 195 may start charging again at t3, as shown in timing line 408.

The specification has described systems and methods for improving power backup of a desktop computer. The illustrated steps are set out to explain the embodiment shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the invention.

Consistent with disclosed embodiments, one or more hardware processors may execute instructions to perform various disclosed operations. Furthermore, tangible computer-readable storage media may store program instructions that are executable by the one or more processors to implement any of the processes disclosed herein. The tangible computer-readable storage media may be a volatile or non-volatile, magnetic, semiconductor, tape, optical, removable, non-removable, or other type of storage device or non-transitory computer readable medium.

What is claimed is:

1. A system for providing power to a first device and a second device from a secondary power source comprising:
a current rectifier;
a first switch;
a second switch; and
a secondary power source management system;
wherein the current rectifier converts a primary power source comprising an alternating current into a direct current that supplies power to the first device, the second device, and the secondary power source management system;
wherein, upon an interruption in the primary power source, the first switch activates to allow the secondary power source to directly supply power to the first device and, following a time delay, signals the second switch to allow the secondary power source to directly supply power to the second device; and
wherein the secondary power source supplies power to the first device and second device using direct current.

2. The system of claim 1, wherein the secondary power source supplies power to the first device and second device without use of a power inverter that converts direct current into alternating current or a current rectifier that provides a second conversion of alternating current into a direct current.

3. The system of claim 1, wherein the first device is a computer motherboard, and the second device is a display.

4. The system of claim 3, wherein the computer motherboard comprises low-powered components having a composite power rating less than 45 watts.

5. The system of claim 1, wherein the time delay ranges from about 200 to about 300 microseconds.

6. The system of claim 1, wherein the time delay is configurable by a user.

7. The system of claim 1, wherein the secondary power source management system charges the secondary power source in the absence of an interruption in the primary power source based on the power level of the secondary power source.

8. A method for providing power to a first device and a second device from a secondary power source comprising:
rectifying a primary power source that supplies power to the first device and the second device from an alternating current to a direct current;
detecting an interruption in the primary power source;
upon detecting an interruption in the primary source, supplying power directly to the first device from the secondary power source and, following a time delay, supplying power directly to the second device from the secondary power source using direct current.

9. The method of claim 8, wherein no other rectifying step is performed.

10. The method of claim 8, wherein the first device is a computer motherboard, and the second device is a display.

11. The method of claim 10, wherein the computer motherboard comprises low-powered components having a composite power rating less than 45 watts.

12. The method of claim 8, wherein the time delay ranges from about 200 microseconds to about 300 microseconds.

13. The method of claim 8, wherein the time delay is configurable by a user.

14. The method of claim 8, further comprising:
charging the secondary power source in the absence of an interruption in the primary power source.
